(19) United States
(12) Patent Application Publication
(10) Pub. No.: US 2009/0144140 A1
(43) Pub. Date: Jun. 4, 2009

(54) IN-GAME IMPRESSIONS

(75) Inventors: Daniel Willis, Gilroy, CA (US); Michael Doiron, Ontario (CA)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/948,619

(22) Filed: Nov. 30, 2007

(51) Int. Cl. G06Q 30/00; A63F 13/00

(52) U.S. Cl. 705/14; 463/31

(57) ABSTRACT

An impression policy associated with impression policy criteria is created and transmitted to one or more game consoles. The impression policy is applied to all possible content impressions (e.g., advertisement impressions) that occur during game play. The content impressions that satisfy impression policy criteria are reported as actual content impressions.

### FIELD

This document relates to in-game advertising.

### BACKGROUND

During recent years, computer gaming has gained increasing popularity, and today numerous players are playing games all around the world. Predictably, interactive computer gaming, such as on Internet enabled platforms, has blurred the line between games and other entertainment or communication media.

Due to their dynamic nature and specific appeal to certain audiences, computer games and especially games played on Internet enabled platforms provide an ideal vehicle for sponsored content delivery (e.g., advertising). Not only is it possible for an advertiser to target directly a specific group of customers, but also advertisements (“ads”) optionally are incorporated directly into the computer games, enabling something akin to the well-known concept of product placement. In one such system, a game is running on a computer that is connected to the Internet. While playing of the game, the game software contacts one or more advertising content providers, either locally or remotely (e.g., advertising servers) to retrieve advertising content that is available for display to the gamer during game play. The data and advertising content is transferred using, for example, HTTP protocols over the Internet.

When an advertisement (“ad”) is included in a game, a question to be resolved is when does a game player's observation of an advertisement in the game start and stop being an impression? To date the answer to this question is arbitrary, and inconsistent among multiple advertisers, advertisement impressions within one game, and impressions between many games.

### SUMMARY

This specification describes systems, methods and computer program products whereby a centralized impression policy can be established among any and all games. This centralized policy is then automatically applied in all game instances at the client level. In-game ad impressions can be tracked with a broad set of criteria such as length of impression, quality of impression, degree of interaction with the ad product, camera angle, amount of screen real estate, and the degree to which the ad is occluded and several others.

In general, one aspect of the subject matter described in this specification can be embodied in methods that include the actions of identifying content for presentation on a game platform, identifying an impression policy, and generating a report identifying whether the display of the content satisfies the impression policy when displayed during execution of a game on the game platform. Other embodiments of this aspect include corresponding systems, apparatus, and computer program products.

Another aspect of the subject matter described in this specification can be embodied in methods that include receiving an advertisement, receiving an advertising impression policy including at least one impression criteria, displaying the advertisement during execution of a game, where the display of the advertisement is associated with one or more display metrics, comparing the one or more display metrics with the at least one impression criteria, and identifying the display of the advertisement as an advertising impression when the one or more display metrics satisfy the at least one impression criteria.

According to another aspect of the subject matter described in this specification can be embodied in systems including a server, operable to establish an impression policy comprising at least one impression criteria, and a game platform. The game platform is operable to execute a game, where the execution of the game includes the display of at least one advertisement, identify the at least one impression criteria, and determine whether the display of the at least one advertisement satisfies the at least one impression criteria.

These and other embodiments permit the implementation of a centralized impression policy that is automatically applied in all in-game content delivery (e.g., ad delivery) to ensure that participants in the in-game advertising value chain are receiving good return on their investment (ROI).

### BRIEF DESCRIPTION OF THE DRAWINGS

FIG. 1 shows an example advertising system.

FIG. 2 shows an example advertising process performed in the advertising system of FIG. 1.

FIG. 3 shows an example impression policy table representing an impression policy.

FIG. 4 shows an example impression policy distribution process.

FIG. 5a shows an example impression policy application process.

FIG. 5b shows another example impression policy application process.

FIG. 6 shows an example process for applying an impression policy during game play.

### DETAILED DESCRIPTION

When content (e.g., an advertisement) is displayed within a game, whether or not the display should be deemed to be impression can vary because of the variability of a gaming environment. Video game play can involve a virtual world/universe. Factors and environmental issues that exist in the real world can also play a part in the impressions in the virtual world. Consider the example of a game in which someone driving down a freeway that has advertising billboards on the side of the road. If the road is long and straight and the terrain relatively flat, it may be possible to see the outline of the billboard from a fair distance away, measured in miles (e.g., 2-5 miles). However, a driver at 5 miles from the advertisement cannot discern any details from the sign. At what point does the sign become “readable”, i.e., eligible as an actual advertisement impression? Other game play environmental factors, such as where other objects block the view of a content item (e.g., a truck driving beside a player in a driving game), or a content item is viewed at a sharp angle to make it difficult to see or read can also impact whether an actual impression occurs.

The present specification describes a solution in which all impressions of a given type, e.g. a virtual billboard in the game, are consistently measured for all impressions within the same game, for all players of the game and on all platforms on which the game is played. This provides advertisers a realistic measurement by which they can compare impressions, and enables them to better understand their ROI for a given ad or campaign. This is valuable to advertisers and their agents who seek to grasp the value of their efforts and of their advertising expenditures. Additionally, the ability to understand and therefore optimize ROI translates to greater advertising efficiencies, potentially leading to an overall savings for advertiser.

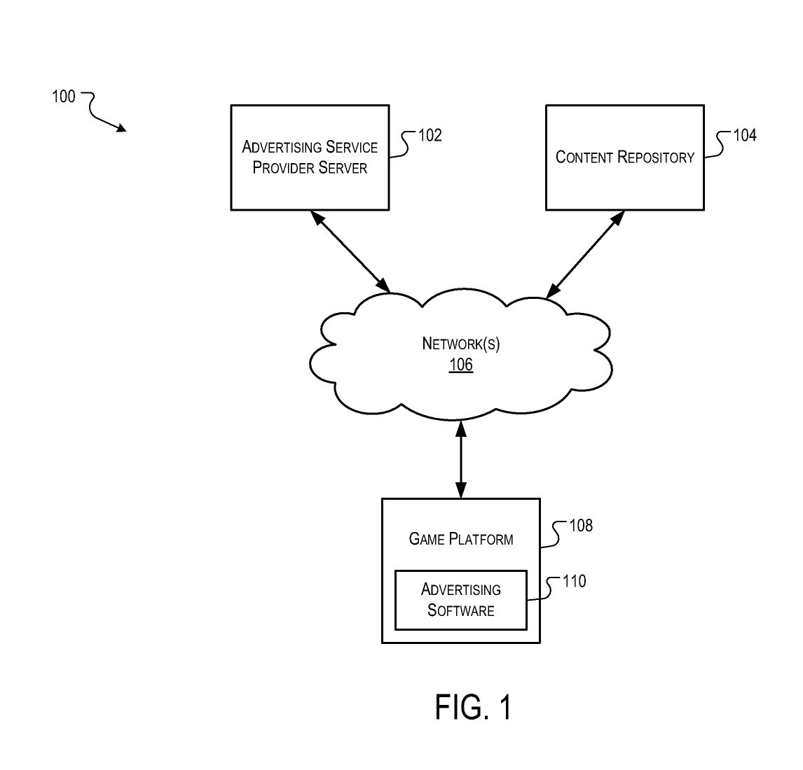

FIG. 1 shows an example advertising system 100 for in-game advertising. The system 100 includes an advertising service provider service (ASPS) 102, a content repository 104, and a game platform 108, where each is in communication with at least one network 106. According to some implementations, the ASPS may include a server. The ASPS 102 implements one or more ad campaigns by uploading advertising content, managing the advertising content, and delivering it to the game platform 108. The ASPS 102 maintains the lists of advertising placement inventory for each game, and also maintains the advertisements and their mappings to the placement inventory positions. The ASPS 102 can also collect and manage advertising impression metrics generating the performance reports, billing and payouts. Ad content can be uploaded by the ASPS 102 from the content repository 104 over the network(s) 106. While reference is made to ad content, other forms of content including other forms of sponsored content can be managed by the ASPS 102.

The game platform 108 represents one or more devices through which a user can play a game that includes the display of content (e.g., advertisements) provided by the ASPS 102. The game platform 108 can include advertising software 110 to embed advertisements in the game. The advertisement software 110 can include an instrumentation element (not shown) that allows for the tracking and logging of advertisement impressions as observed by the game. The advertisement software 110 facilitates the communication of impressions to the ASPS 102. The game platform 108 can include persistent storage to maintain advertising data, for instance, during or across games. Further, the game platform 108 can include storage to support local, cached advertisements for presentation within a game.

The one or more networks 106 can include a local area network (LAN), a wide area network (WAN), a virtual private network (VPN), a telephone network, such as the Public Switched Telephone Network (PSTN), an intranet, the Internet, one or more wireless networks, or a combination of networks. The game platform 108 can include a networked entertainment device, including gaming consoles such as the Sony Playstation 2 and 3, Microsoft Xbox 360, and Nintendo Wii, network-connected mobile gaming platforms, such as the Nintendo DS, Sony PSP, and the Nokia N-gage, mobile phones, digital set top boxes, entertainment media enabled personal computers and the like.

For the sake of illustration, FIG. 1 shows a single game console 108, advertising service provider server 102, and content repository 104 connected to the network 106; however, it will be appreciated that in practice there may be more game consoles, ASPSs, and/or content repositories. Additionally, some of the components shown in FIG. 1 can be combined. For instance, the content repository 104 can be included within or as part of the ASPS 102. Additionally, one or more other system components may exist that are not illustrated. For instance, a broker or management entity may act as an intermediary between multiple ASPSs and one or more game platforms, for instance, to manage which ASPSs will deliver content to each one of numerous game platforms.

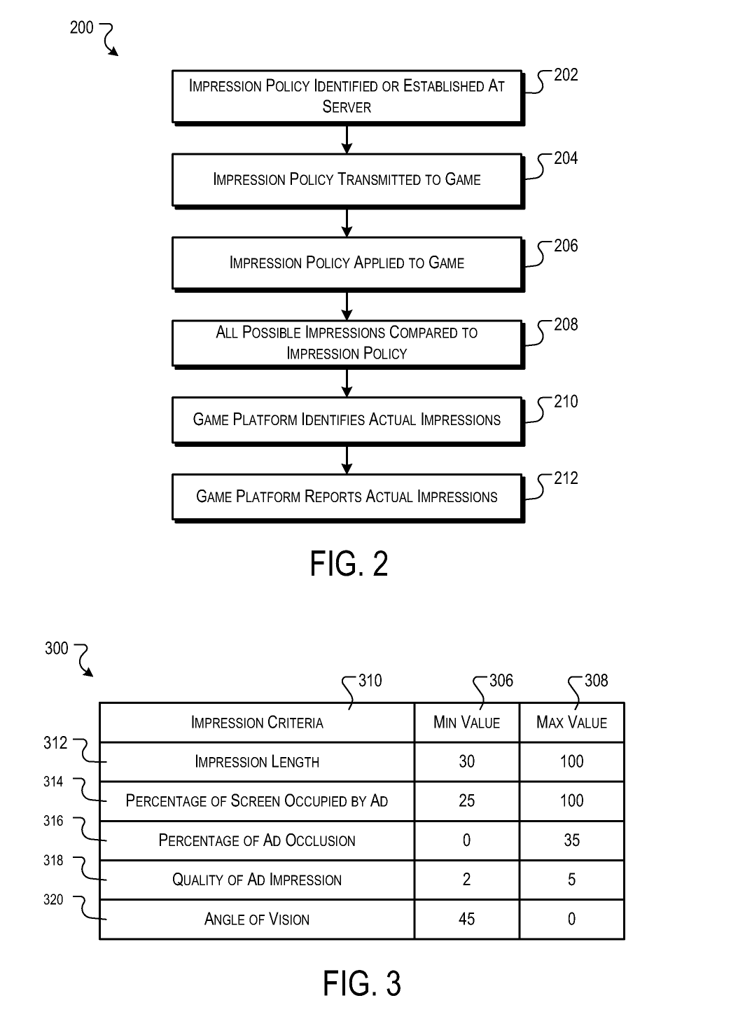

FIG. 2 shows an example advertising process 200 performed in the advertising system 100 of FIG. 1. The process 200 starts with the establishment of an impression policy 202. For instance, a user-administrator can establish the impression policy at the ASPS 102. Next, the impression policy is transmitted (as required) to the game platform 204. For instance, the ASPS 102 can transmit the impression policy to a game platform 108 via the one or more network(s) 106. The game platform stores the received impression policy and applies it to a game 206, such that it will apply to all possible impressions observed in the game by a user-player of the game. As game play proceeds the game platform, compares all possible impressions to the impression policy 208. This can occur, for instance, using the advertising software 110 of the game platform 108. The game platform identifies all impressions that satisfy the impression policy 210. The game platform then reports back to the ASPS 102 all impressions (i.e., ‘actual impressions’) that satisfy the impression policy 212.

FIG. 3 shows an example impression policy table 300 that represents an impression policy. The impression policy is a set of rules that govern when an actual impression of an in-game advertisement occurs. The impression policy is applied against all possible (i.e., observed) impressions in a game. The impression policy can include at least one or more of the impression criteria 310 shown in the impression policy table 300. Examples of these include the impression length 312, the percentage of screen occupied by the ad 314, the percentage of ad occlusion 316, the quality of the ad impression 318, and the angle of vision 320. Other criteria are possible. As shown in the impression policy table 300, each impression criteria can be associated with minimum and maximum values 306, 308 that identify when that impression criteria is satisfied. An impression criteria is satisfied when a measure value provided by a game falls within or equal to the minimum and maximum values for that impression criteria. An actual advertisement impression is identified when a sufficient number or percentage of impression criteria are satisfied.

The impression length 312 impression criteria is expressed in the number of continuous screen frames in which any part of an advertisement is visible (i.e., observed). This criteria may be expressed by a number of frames. In the impression policy table 300 shown in FIG. 3 the minimum and maximum values are 30 and 100 frames, respectively. Although not illustrated in FIG. 3, a frame rate may be transmitted with or included within the impression policy such that an impression length can be normalized. As an example, the minimum and maximum values may be based on a frame rate of 5 frames per second. Therefore, if any part of the advertisement is observed continually for a minimum of 6 seconds and a maximum of 20 seconds, the impression length criteria will be deemed to be satisfied. Thus, if a game provides a frame rate of 10 frames per second, twice the value on which the minimum and maximum values are provided, the game can adjust the minimum and maximum values by doubling each. Although the impression length can be measured by a number frames, it may alternatively be expressed as a length of time, such as in seconds.

The percentage of screen occupied by advertisement 314 impression criteria is expressed as a percentage of the screen that is occupied by an advertisement. For instance, in the impression policy table 300 shown in FIG. 3 the minimum and maximum values represent that an observed impression must occupy at least 25% of a screen for this criteria to be satisfied. The percentage of ad occlusion 316 impression criteria can also be represented by a percentage value, which expresses the percentage of an advertisement that is hidden. For instance, in one implementation, a value of 100% indicates that the entire advertisement is occluded, for instance, by another game object that may be in front of the advertisement. As shown in the example of FIG. 3, an advertisement can be no more than 35% occluded, else the advertisement will not be deemed to meet the percentage of ad occlusion 316 impression criteria.

Next, the quality of ad impression 318 criteria can be, in one implementation, an arbitrary value associated with advertisement impressions to weight advertisement observations in a game. The quality of ad impression criteria values qualitative aspects of a possible advertising event, for example the degree of interaction with an advertisement. For instance, if an advertisement is an actual item, such as a beverage having a recognizable brand (e.g., due to the item's color, name, shape, trade dress, or the like), the quality of the ad impression may vary based on whether it was not being interacted with (e.g., just sitting on a table) or not, and/or based on a level of interaction. For instance, in the illustrative example of a beverage, one or more quality values may be associated with the advertisement when a game player spills it, grabs it, drinks it, and the like. As shown in FIG. 3 the minimum and maximum values are 2 and 5, respectively. These values may be associated with required levels of interaction. Exemplary activities corresponding to levels of interaction (e.g., levels 1 though 5) may be transmitted with the impression criteria such that the advertising software can be programmed to identify qualitative values (e.g., of interaction) during game play.

The angle of vision 320 impression criteria represents the perceived angle from which the advertisement is viewed. This criteria can be expressed as degrees off center in the line of sight from a game player's point of view. For instance, an angle of 0 means that the advertisement is in direct view of the game player, and angle of 90 means that the player is looking at a right angle (i.e., 90 degrees) to the advertisement, and an angle of 180 means that the game player is looking directly away from an object.

In some implementations an actual impression occurs when all of the display metrics of an observed impression fall within the inclusive boundary values (e.g., minimum and maximum values) of all the impression criteria. Although described with respect to minimum and maximum values, in some implementations impression criteria may be associated only with minimum values. In those implementations, the impression criteria can be satisfied by display metrics exceed the minimum values.

If a game does not track a particular characteristic then that characteristic can be exempt from the corresponding boundary value constraints. For example, in an observed impression where only the impression length, quality of impression, and angle of vision are collected and reported, the observed impression will not be measured against the percentage of screen occupied by the ad and the percentage of ad occlusion.

Impression criteria other than the impression criteria illustrated in the impression policy table 300 shown in FIG. 3 may be established. For instance, the cumulative time an impression is observed during game play may be an impression criteria. Additionally, one or more impression criteria can include explicit values for exclusion of an observed advertisement being deemed an actual impression. Impression criteria can also identify invalid values associated with certain observed impressions during game play.

Additionally, attributes may be associated with each impression criteria. This allows the impression policy to indicate whether the impression criteria can or cannot be overridden. For instance, each impression criteria can be associated with an attribute of ‘False’ that indicates that the game developed must use the attributes in evaluating an observed impression. In some implementations, impression criteria can include at least one Boolean value, defaulting to ‘False’, that indicates whether a game developer can override the impression criteria with their own suggestions.

The set of impression criteria defining an impression policy can be configured to be applicable for a single title, genre, platform, or can be applied across a wider set of games, perhaps all of them managed by the ASPS. In some implementations, the impression criteria can take the form of an XML document. Applying an impression policy for similar games, genres, and the like, permit the establishment of consistent criteria for determining when ad impressions occur.

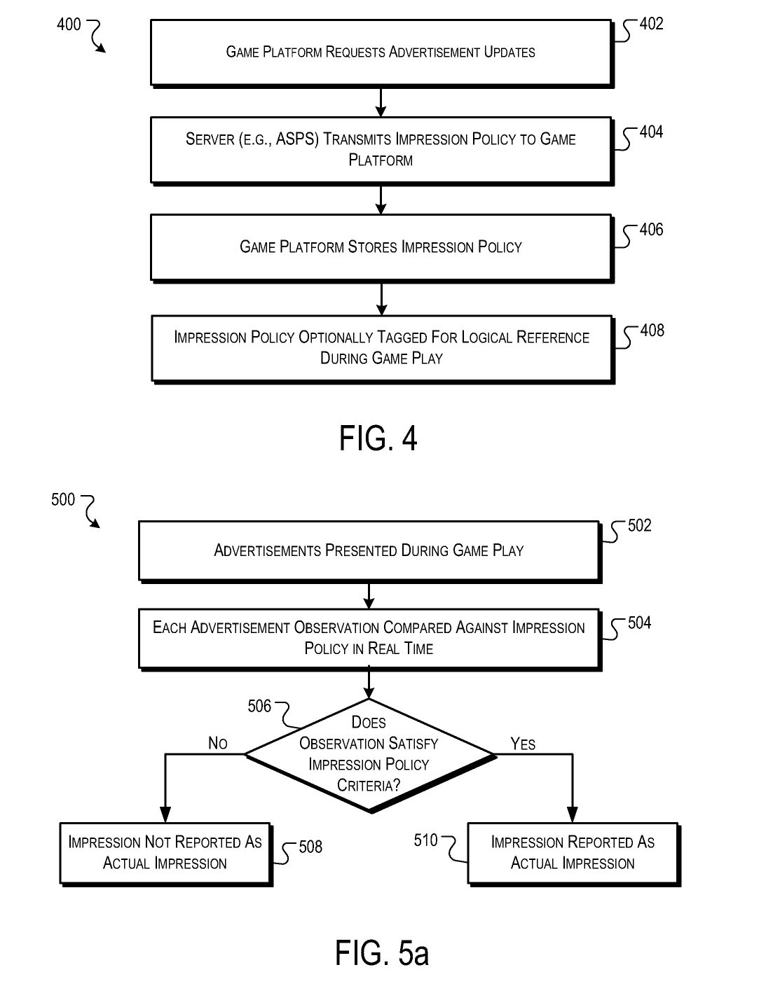

FIG. 4 shows an example impression policy distribution process 400. The example impression policy distribution process 400 may represent the impression policy transmission process at block 204 of FIG. 2. Upon the start of a game, the game platform can request advertisement updates 402. Advertisement updates can include updates to advertisement content, advertising content schedules and the like. Along with advertisement updates, the ASPS can transmit the impression policy to the game, where the impression policy includes impression criteria 404. In some implementations, the impression criteria can be transmitted to a game platform via an XML message. The game platform stores the impression policy 406. For instance, the game platform can store the impression policy in temporary or permanent storage within the game platform. The game platform can optionally tag the impression policy for logical referencing during game play 408.

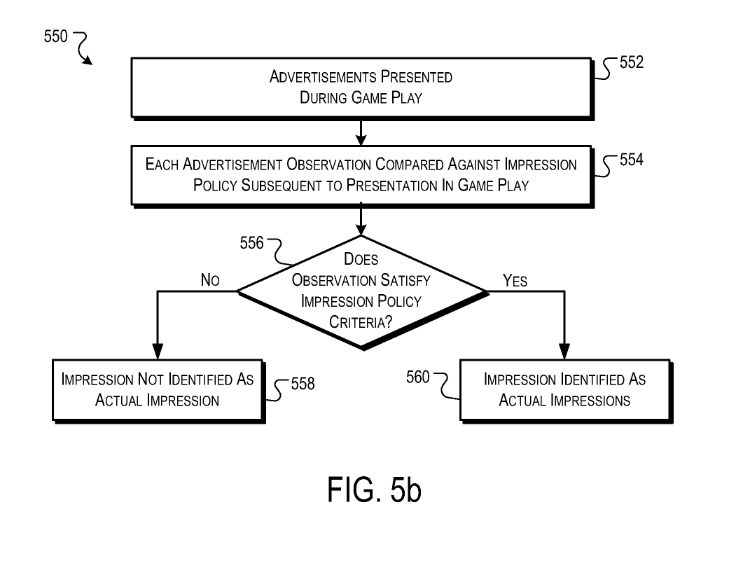

FIG. 5a shows an example impression policy application process 500. The example impression policy application process 500 may represent the impression policy application process at block 206 of FIG. 2. During game-play, advertisements are presented 502. The impression policy can be applied in real time by tagging or filtering ads that satisfy or fail to satisfy policy impression criteria.

According to some implementations, each advertisement observation (i.e., all instances in which advertisements appear during game play, whether or not those satisfy impression policy criteria) is compared against the impression policy in real time 504. For instance, the advertising software 110 can compare advertisement observations against the impression policy criteria. This process includes collecting game play metrics and applying them against the impression policy criteria to determine if one or more (e.g., all) of the impression policy criteria are satisfied. If an advertisement observation fails to satisfy the impression policy criteria the observed impression can be disregarded, e.g., not reported as an actual impression 506, 508. If an advertisement observation satisfies the impression policy criteria, the observed impression is identified as an actual impression 506, 510.

While the observed impression satisfies the impression policy criteria, the impression continues to be captured, i.e., the length of the impression grows. When the observed impression fails to meet the impression policy criteria, the impression is suspended, or optionally, ends. When the impression falls back within bounds of the impression criteria, the impression is resumed, or optionally, a new impression is begun.

According to some implementations, observed advertisement impressions may be tagged (e.g., in real-time) as either satisfying or failing to satisfy impression policy criteria. By tagging all impressions as either satisfying or failing to satisfy impression criteria, all impression data can be tracked and maintained. This permits the tracking of all observed impressions, which may be useful in performing ‘what if’ analyses that can identify, for instance, how changes to an impression policy impact the number of actual impressions.

According to yet another implementation of real time filtering, after an advertisement is deemed to satisfy all impression criteria but for impression length an impression criteria timer can be started. The timer will stop counting if any or all of the other observed metrics fall outside the valid ranges of impression criteria specified by the impression policy.

FIG. 5b shows another example impression policy application process 550. The example impression policy application process 550 may represent the impression policy application process at block 206 of FIG. 2. As an alternative to real time analysis, the impression policy can be applied to observed advertisements subsequent to their presentation during game play. According to an implementation, advertisements are presented during game play 552, and a game platform can log game play metrics for each observed advertisement impression in an observed data record stored by the game platform. The observed data record can include data sufficient to determine whether one or more of the impression criteria are satisfied. For instance, the observed data record can include data including the impression length of an observed impression, the frame rate, the percentage of screen size of an observed impression, the percentage of occlusion, the quality of an observed ad impression, and the angle of vision of the observed impression. A tag may be associated with each observed advertisement impression, where the tag uniquely associates the observed advertisement impression with the impression policy in advertising software 110.

Observed impressions stored in the observation record are compared against the impression criteria 554 associated with the applicable (i.e., in effect) impression policy. Observed impressions may be given a ‘valid’ tag that indicates that an observed impression satisfies the impression policy and is thus an ‘actual impression’ 556, 568, while an ‘invalid’ tag may be given to observed impressions that fail to satisfy the impression policy 556, 558. An observed impression data set can be created that includes the observed data record, the impression policy, and the validity tag that indicates whether an observed impression satisfies the impression policy. The observed impression data set can be transmitted, for instance, to the ASPS.

In some implementations, invalid impressions can be deleted from the observed impression data set and/or observed data record, such that only actual impressions exist in the observed impression data set and/or observed data record. Additionally, in some implementations, the observed impression data set is transmitted to the ASPS and the filtering of invalid observations can then be performed in the same manner at the ASPS. When performed at the ASPS, the ASPS can alter the impression policy between observation and reporting.

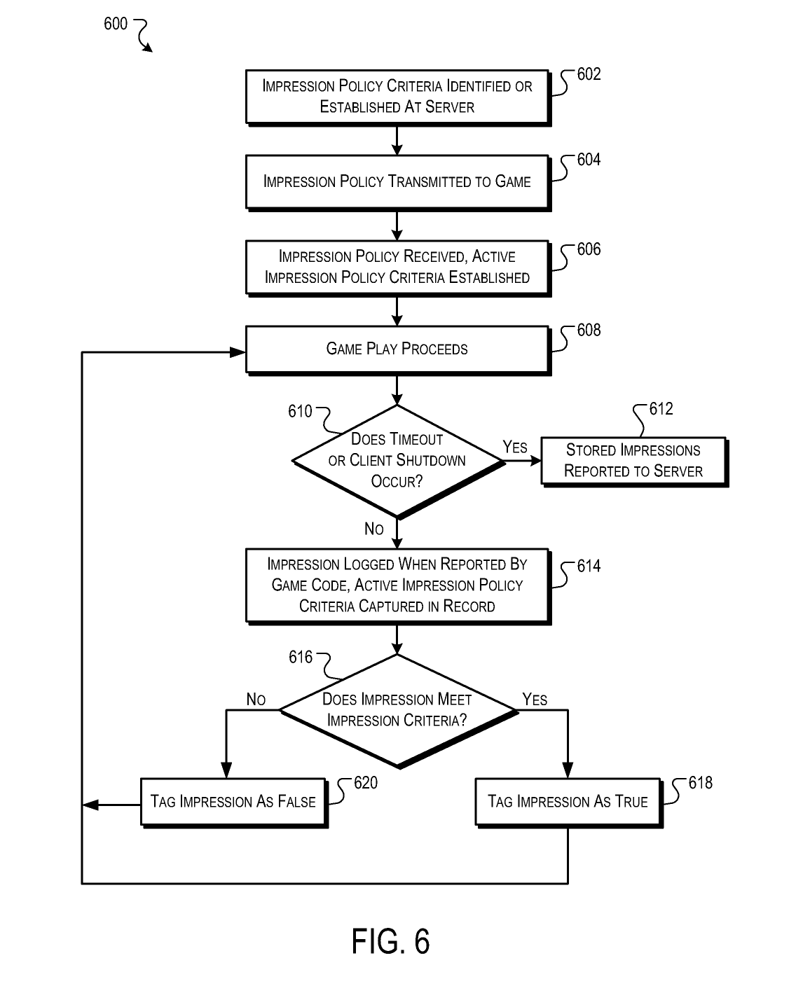

FIG. 6 shows an example process for applying an impression policy during game play. An impression policy including impression policy criteria is established (e.g., at a server such as ASPS 102) 602. The impression policy is transmitted to the game 604, for instance, to the game platform 108 over one or more networks 106. The game receives the impression policy and associates the impression policy criteria with the game 606 such that it can be applied to observed ad impressions as game play proceeds 608. For instance, the impression policy and impression criteria can be applied to game play by the advertising software 110. While the game play proceeds, observed impressions are logged 614, for instance, in an observed data record. This can occur, for instance, in real time by the advertising software 110. However, as described above, this could also occur after the expiration of game play, at regular intervals, or during suspension of game play.

If an observed impression meets the impression criteria associated with the impression policy 616, 618, the impression is tagged as valid. If the observed impression fails to meet the impression criteria associated with the impression policy 616, 620, the impression is tagged as invalid. The tagged impressions are stored in the observed impression data set, and the process of comparing observed impressions to impression criteria of the impression policy and storing tagged impressions continues until the game is ended or suspended 610. Thereafter, stored impressions in the observed impression data set are transmitted to the server, such as the ASPS 612. While reference is made to storing both valid and invalid impressions, in some implementations only valid tagged impressions are stored. Similarly, only valid impressions can be reported or otherwise communicated.

The systems, apparatus, and methods described in this specification may be implemented in computer processing systems including program code including program instructions that are executable by the computer processing system, which may be made up of one or more computers at one or more locations. Other implementations may also be used.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method, comprising:
identifying content for presentation on a game platform;
identifying an impression policy; and
generating a report identifying whether the display of the content satisfies the impression policy when displayed during execution of a game on the game platform.

2. The method of claim 1, wherein identifying the impression policy comprises identifying an impression policy including at least one impression criteria.

3. The method of claim 2, wherein the at least one impression criteria is selected from the group of impression criteria consisting of impression length, percentage of screen occupied by the content, percentage of content occlusion, quality of the content impression, and angle of vision.

4. The method of claim 3, further comprising determining whether the content satisfies the impression policy.

5. The method of claim 4, wherein determining whether the content satisfies the impression policy by determining if the display of the content satisfies the at least one impression criteria.

6. The method of claim 5, further comprising identifying one or more display metrics associated with the display of the content.

7. The method of claim 6, wherein determining if the display of the content satisfies the at least one impression criteria comprises determining if the one or more display metrics satisfy the at least one impression criteria.

8. The method of claim 7, wherein determining if the one or more display metrics satisfy the at least one impression criteria comprises determining if the one or more display metrics exceed one or more boundary values corresponding to the at least one impression criteria.

9. The method of claim 1, wherein the report identifies only content that satisfies the impression policy.

10. A method, comprising:
receiving an advertisement;
receiving an advertising impression policy including at least one impression criteria;
displaying the advertisement during execution of a game, where the display of the advertisement is associated with one or more display metrics;
comparing the one or more display metrics with the at least one impression criteria; and
identifying the display of the advertisement as an advertising impression when the one or more display metrics satisfy the at least one impression criteria.

11. The method of claim 10, wherein comparing the one or more display metrics with the at least one impression criteria occurs during the execution of the game.

12. The method of claim 10, wherein comparing the one or more display metrics with the at least one impression criteria occurs subsequent to the execution of the game.

13. The method of claim 10, wherein the at least one impression criteria is selected from the group of impression criteria consisting of impression length, percentage of screen occupied by the advertisement, the percentage of advertisement occlusion, the quality of the advertisement impression, and the angle of vision.

14. The method of claim 10, wherein comparing the one or more display metrics with the at least one impression criteria comprises determining if the one or more display metrics fall within one or more boundary values corresponding to the at least one impression criteria.

15. The method of claim 10, further comprising reporting the advertising impression to at least one remote server.

16. The method of claim 15, wherein reporting the advertising impression occurs subsequent to the execution of the game.

17. The method of claim 10, wherein identifying the display of the advertisement as an advertising impression when the one or more display metrics satisfy the at least one impression criteria comprises tagging a record of the display of the advertisement as an advertising impression.

18. A system, comprising:
a server, operable to establish an impression policy comprising at least one impression criteria; and
a game platform operable to:
execute a game, where the execution of the game includes the display of at least one advertisement;
identify the at least one impression criteria; and
determine whether the display of the at least one advertisement satisfies the at least one impression criteria.

19. The system of claim 18, wherein the game platform is operable to determine whether the display of the at least one advertisement satisfies the at least one impression criteria during the execution of the game.

20. The system of claim 18, wherein the game platform is operable to determine whether the display of the at least one advertisement satisfies the at least one impression criteria subsequent to the execution of the game.

21. The system of claim 18, wherein the game platform is further operable to transmit a report to the server, the report identifying that the at least one advertisement satisfies the at least one impression criteria.

22. The system of claim 18, wherein the game platform is further operable to transmit a report to the server, the report identifying that the at least one advertisement fails to satisfy the at least one impression criteria.

23. The system of claim 18, wherein the game platform is operable to determine whether the display of the at least one advertisement satisfies the at least one impression criteria by determining if one or more display metrics associated with the display of the at least one advertisement satisfies the at least one impression criteria.

24. The system of claim 23, wherein the game platform is operable to determine if one or more display metrics associated with the display of the at least one advertisement satisfies the at least one impression criteria by determining if the one or more display metrics fall within one or more boundary values corresponding to the at least one impression criteria.
